(19) United States
(12) Patent Application Publication
(10) Pub. No.: US 2011/0013387 A1
(43) Pub. Date: Jan. 20, 2011

(54) Directional Linear Light Source

(75) Inventors: Udayan Kanade, Pune (IN); Pushkar Apte, Rochester, NY (US); Ruby Rama Praveen, Pune (IN); Sanat Ganu, Pune (IN); Sumeet Katariya, Pune (IN); Alok Deshpande, Madison, WI (US); Parag Khairnar, Bengaluru (IN)

Correspondence Address: Udayan Kanade, 15-1 Sharman, Sahajanand Hsg Soc, Kothrud, une, 411038, IN

(73) Assignee: I2IC CORPORATION, Foster City, CA (US)

(21) Appl. No.: 12/933,429

(22) PCT Filed: Mar. 19, 2009
(86) PCT No.: PCT/IB09/51171

§ 371 Date: Sep. 20, 2010

(30) Foreign Application Priority Data
Mar. 19, 2008 (IN) 551/MUM/2008

(51) Int. Cl. G02B 6/00; F21V 11/00; F21V 7/00

(52) U.S. Cl. 362/224; 362/217.02; 362/217.05

(57) ABSTRACT

An apparatus and method for providing a linear light source emitting light in a narrow cone of directions is disclosed. In one embodiment, the apparatus comprises a linear light source and a sheet designed in such a way that light is emanated out in a narrow set of directions. Also disclosed is a directional surface light source using a directional linear light source.

This application claims priority from provisional patent application number 551/MUM/2008 titled “Extraction of Light from a Light Source in a Preferred Emanation Pattern” filed on 19 Mar. 2008 in Mumbai, India.

### TECHNICAL FIELD

The present invention relates to light sources. In particular it relates to light sources which emit light in a narrow cone of directions.

### BACKGROUND ART

Illumination is used to light objects for seeing, as also for photography, microscopy, scientific purposes, entertainment productions (including theater, television and movies), projection of images and as backlights of displays.

Furthermore, illumination is often required to be directed onto an object in a particular manner. For example, illumination sources for photography need to be diffused, illumination sources for backlights of displays need to be uniform and illumination sources for theater spotlights need to be highly directional.

There are prior art systems such as fluorescent tubes that act as linear light sources. The light from these sources is not emitted in some preferred direction but is emitted equally in all directions.

Light sources that emanate light in a narrow cone of directions are used as backlights of displays. This saves energy for personal viewing of displays, since lesser light energy is wasted in directions where a viewer is not present.

### DISCLOSURE OF INVENTION

### Summary

An apparatus and method for providing a linear light source emitting light in a narrow cone of directions is disclosed. In one embodiment, the apparatus comprises a linear light source and a sheet designed in such a way that light is emanated out in a narrow set of directions. Also disclosed is a directional surface light source using a directional linear light source.

The above and other preferred features, including various details of implementation and combination of elements are more particularly described with respect to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1A illustrates a directional linear light source, according to an embodiment.

FIG. 1B illustrates a directional linear light source, according to an embodiment.

FIG. 1C is a schematic plot of the light emanation pattern of a directional linear light source, according to one embodiment.

FIG. 2A illustrates a directional linear light source, according to an embodiment.

FIG. 2B is a schematic plot of the light emanation pattern of a directional linear light source with two prism sheets, according to one embodiment.

FIG. 3 illustrates a linear light source, according to one embodiment.

FIG. 4 illustrates an exemplary element of a light guide having light deflector, according to one embodiment.

FIG. 5 illustrates an exemplary linear light source having a varied concentration of light deflecting particles, according to one embodiment.

FIG. 6 illustrates an exemplary linear light source having two light sources, according to one embodiment.

FIG. 7 illustrates an exemplary linear light source having a mirrored light guide, according to one embodiment.

FIG. 8A is a side view of a directional linear light source, according to an embodiment.

FIG. 8B illustrates a directional linear light source using a single prism, according to an embodiment.

FIG. 9A illustrates a directional linear light source having aspherical particles, according to one embodiment.

FIG. 9B is a detailed partial view of directional linear light source having aspherical particles, according to one embodiment.

FIG. 10 illustrates a directional linear light source having slanted sheets, according to one embodiment.

FIG. 11A illustrates a directional surface light source, according to one embodiment.

FIG. 11B is a detailed partial side view of a directional surface light source, according to one embodiment.

FIG. 12A illustrates a directional surface light source, according to one embodiment.

FIG. 12B is a detailed partial front view of a directional surface light source, according to an embodiment.

FIG. 13 is a side view of a directional surface light source, according to one embodiment.

FIG. 14A illustrates a surface light source having an etched tapering sheet light guide.

FIG. 14B is the side view of a surface light source, having an etched tapering sheet light guide.

### DETAILED DESCRIPTION

An apparatus and method for providing a linear light source emitting light in a narrow cone of directions is disclosed. In one embodiment, the apparatus comprises a linear light source and a sheet designed in such a way that light is emanated out in a narrow cone of directions. Also disclosed is a directional surface light source using a directional linear light source.

### GLOSSARY OF TERMS

A reflector is any means of reflecting light. Specular light reflectors or mirrors include metallic surfaces, distributed Bragg reflectors, hybrid reflectors, total internal reflectors or omni-directional reflectors. Diffuse light reflectors include paints, suspensions of transparent materials, dyes, etc.

A point light source is a light source emitting light from a small region. E.g. an LED (Light Emitting Diode), a LASER (Light Amplification by Stimulated Emission of Radiation) or a filament can act as a point light source. A small linear or surface light source (described below) can also be considered to be a point light source when viewed from afar, or when emitting light into a much larger body.

A linear light source is a light source emitting light from a region which has one large dimension. A linear light source could be shaped like a tube with circular, square or other cross section, for example. E.g. a bank of LEDs, a fluorescent tube, a gas discharge tube, an incandescent filament.

A surface light source is a light source emitting light from a region which has two large dimensions. A surface light source will have at least one large light emitting surface. It may have a small thickness, i.e. it may be in the form of a sheet.

A directional light source is a light source emanating light in a narrow cone of directions.

A light guide is an object which guides light within it. It may use total internal reflection, or other means of conducting light.

A linear light guide is a light guide with one large dimension.

A sheet light guide is a light guide with two large dimensions.

A prism sheet is a sheet made of transparent material, with at least one surface shaped in the form of multiple prisms, oriented parallel to each other. The prisms may have a triangular or polygonal cross section. They could have other more complex cross sections such as segment of a circle, segment of a parabola, etc.

The spherical coordinate system is a system of naming directions using two numbers. The polar angle is the angle made by the particular direction with a fixed direction, the pole. The azimuthal angle is the angle made by the plane containing the particular direction and the pole, with a base plane. The base plane contains the pole.

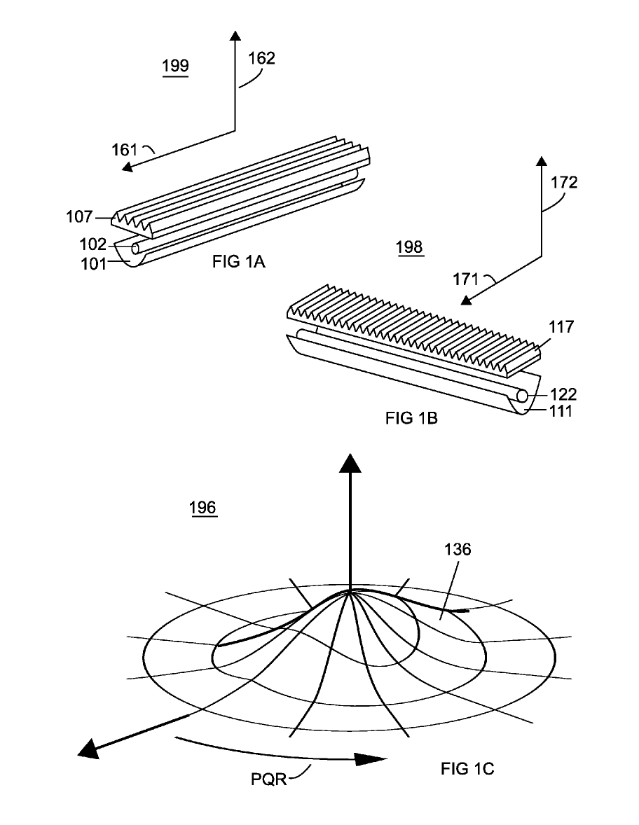

FIG. 1A illustrates a directional linear light source 199, according to an embodiment. A linear light source 102 is placed between a prism sheet 107 and a reflector 101. The light from the linear light source 102 reaches the prism sheet 107 directly, or after reflecting off the reflector 101. In an embodiment, the prism sheet is oriented such that the prism rows are parallel to the linear light source 102. The diagram shows the orientation axis 161 of the prism sheet 107, the orientation axis being the direction that all the prisms lie parallel to. The directional linear light source 199 emanates a large amount of light in a narrow cone around the principle output direction 162, which is the direction perpendicular to the plane of the prism sheet 107.

FIG. 1B illustrates a directional linear light source 198 according to an embodiment. A linear light source 122 is placed between a prism sheet 117 and a reflector 111. The prism sheet is oriented such that the prism rows are perpendicular to the linear light source 122. The diagram shows the orientation axis 171 of the prism sheet 117 and the principal output direction 172, which is perpendicular to the plane of the prism sheet 117.

FIG. 1C is a schematic plot of the light emanation pattern 196 of a directional linear light source, according to one embodiment. A spherical coordinate system is used to name light traveling directions. The principal output direction of a directional light source becomes the pole of the spherical coordinate system. The plane containing the principal output direction and the orientation axis of the prism sheet becomes the base plane. In the plot 196, polar angles are represented as radius (distance from the center), azimuthal angles are represented as argument (angle PQR) and the intensity of light is represented as height of the surface 136. Light intensity at directions near the principal output direction is more than light intensity at directions further away (having a larger polar angle). In an embodiment, the light output has a narrower cone when seen perpendicular to the prisms than seen along the prisms. I.e., the light output is more restricted at azimuthal angles 90 degrees and 270 degrees than it is at 0 degrees and 180 degrees.

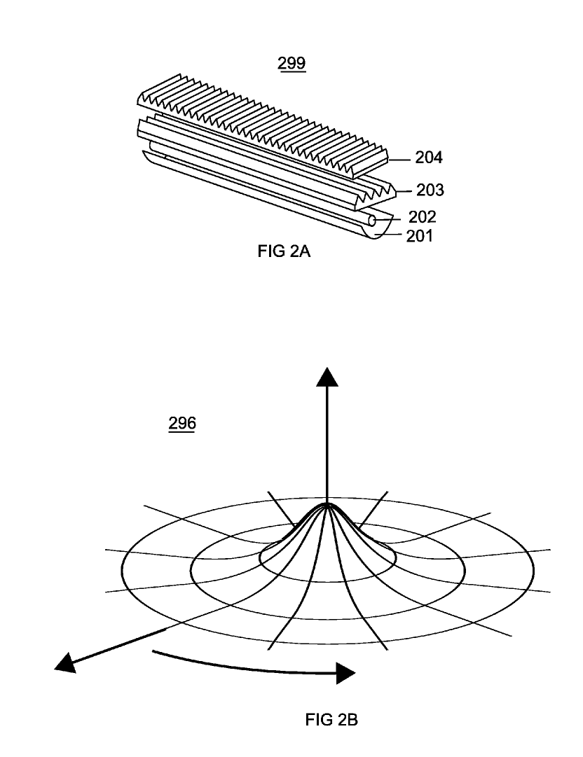

FIG. 2A illustrates a directional linear light source 299 according to an embodiment. A linear light source 202 is placed between a reflector 201 and two prism sheets 203 and 204. The two prism sheets 203 and 204 have their prisms oriented perpendicular to each other. This limits the cone of emanation along the linear light source 202 as well as perpendicular to it.

FIG. 2B is a schematic plot of the light emanation pattern 296 of a directional linear light source with two prism sheets, according to one embodiment. The light output is narrow in all the azimuthal angles.

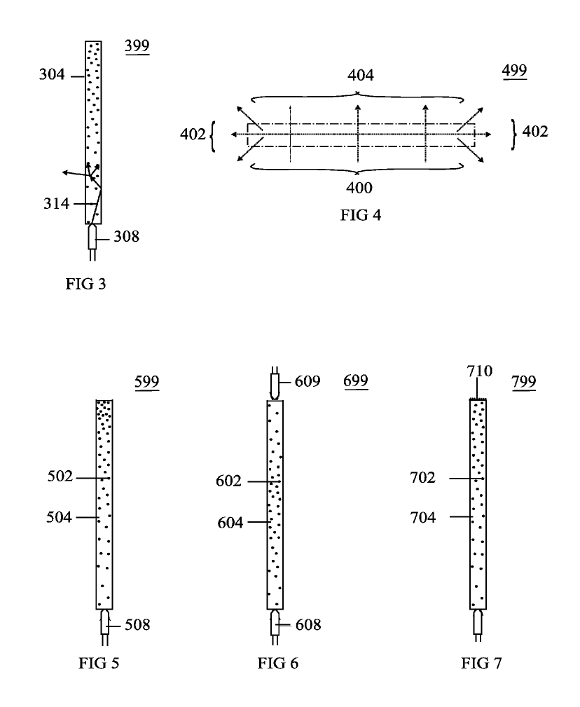

FIG. 3 illustrates a linear light source 399, according to one embodiment. A point light source 308 is placed near one end of linear light guide 304. Linear light guide 304 includes a light deflector such as small transparent particles or bubbles, or metallic particles, or dye or pigment, which disperse light by refraction, reflection or by scattering. Light 314 from point light source 308 enters the linear light guide 304 and is guided within it by total internal reflection. This light is deflected by the light deflector, and emanates over the entire surface of linear light guide 304, thus forming a linear light source. The concentration of light deflector particles may be uniform, or may be varied throughout the linear light guide 304 to achieve a required light emanation pattern. If the power emanated by point light source 308 is changed, the light emanation pattern of light source 399 changes proportionately. If more than one point light sources are used, their power may be changed in tandem to change the light emanation pattern proportionately.

In an embodiment, the concentration of light deflector particles is chosen such that the linear light guide 304 is transparent when viewed from its side, but translucent when viewed from an end, making the linear light source 399 transparent to light entering from outside. Such a transparent light source allows light reflected back from a prism sheet into the light source to pass through the light source and reach the reflector below, which in turn can re-use the light.

FIG. 4 illustrates an exemplary element 499 of a light guide having light deflector, according to one embodiment. Element 499 is a small sliver of the light guide at a particular distance from the end of the light guide that is near a light source. It has a very small height (but the other dimensions of the light guide). The light guide of which element 499 is an element, may be a linear light guide, forming a linear light source.

Light 400, emanated by a light source, and guided by the light guide portion before the element 499, enters element 499. Some of the light gets dispersed due to light deflector included in the light guide, and leaves the light guide as illumination light 402. The remaining light continues on to the next element as light 404. The power of entering light 400 is matched by the sum of the powers of illumination light 402 and continuing light 404. The fraction of dispersed illumination light 402 with respect to entering light 400 is the photic dispersivity of element 499. The ratio of the photic dispersivity of element 499 to the height of element 499 is the photic dispersion density of element 499. As the height of element 499 decreases, the photic dispersion density (of this element) approaches a constant. This photic dispersion density of element 499 bears a certain relationship to the concentration of light deflecting particles in the element 499. The relationship is approximated to a certain degree as a direct proportion. By knowing the concentration of light deflecting particles of element 499, the photic dispersion density of element 499 may be evaluated, and vice versa.

As the height of element 499 is reduced, power in the illumination light 402 reduces proportionately. The ratio of power of illumination light 402 to the height of element 499, which approaches a constant as the height of the element is reduced, is the emanated power density at element 499. The emanated power density at element 499 is the photic dispersion density times the power of entering light 400. The gradient of the power of light traveling through the element 499 is the negative of the emanated power density. These two relations give a differential equation:

dP/dh=−qP=−K

where

h is the distance of the element from the light source end of the light guide,

P is the power of the light being guided through element,

q is the photic dispersion density of element and

K is the emanated power density at element.

This differential equation applies to all elements of the dispersing light guide. It is used to find the emanated power density given the photic dispersion density at each element. This equation is also used to find the photic dispersion density of each element, given the emanated power density. To design a light source with a particular emanated power density pattern (emanated power density as a function of distance from the light source end of the light guide), the above differential equation is solved to determine the photic dispersion density at each element of the light guide. From this, the concentration of light deflecting particles at each element of a light guide is determined.

If a uniform particle concentration is used in the light guide, the emanated power density drops exponentially with distance from the end. Uniform emanated power density may be approximated by choosing a particle concentration such that the power drop from the end near the light source to the opposite end, is minimized. To reduce the power loss and also improve the uniformity of the emanated power, the opposite end reflects light back into the light guide. In an alternate embodiment, another light source provides light into the opposite end.

FIG. 5 illustrates an exemplary linear light source 599 having a varied concentration of light deflecting particles, according to one embodiment. The concentration of light deflecting particles 502 is varied from sparse to dense from the light source end (near light source 508) of light guide 504 to the opposite end.

To achieve uniform illumination, the photic dispersion density and hence the particle concentration has to be varied over the light guide. The photic dispersion density is varied according to

q=K/(A−hK)

where

A is the power going into the light guide 504 and

K is the emanated power density at each element, a constant number (independent of h) for uniform illumination.

If the total height of the light guide 504 is H, then H times K should be less than A, i.e. total power emanated should be less than total power going into the light guide, in which case the above solution is feasible. If the complete power going into the light guide is utilized for illumination, then H times K equals A. In an embodiment, H times K is kept only slightly less than A, so that only a little power is wasted, as well as photic dispersion density is always finite.

FIG. 6 illustrates an exemplary linear light source 699 having two light sources, according to one embodiment. By using two light sources 608, 609, high variations in concentration of light deflecting particles 602 in the light guide 604 is not necessary. The differential equation provided above is used independently for deriving the emanated power density due to each of the light sources 608, 609. The addition of these two power densities provides the total light power density emanated at a particular light guide element.

Uniform illumination for light source 699 is achieved by varying photic dispersion density according to

q=1/sqrt((h−H/2)̂2+C/K̂2)

where

sqrt is the square root function,

̂ stands for exponentiation, and

C=A (A−HK).

FIG. 7 illustrates an exemplary linear light source 799 having a mirrored light guide, according to one embodiment. By using a mirrored light guide 704, high variations in concentration of light deflecting particles 702 is not necessary. Top end 710 of the light guide 704 is mirrored, such that it reflects light back into the light guide 704.

Uniform illumination for light source 799 is achieved by varying photic dispersion density according to

q=1/sqrt((h−H)̂2+D/K̂2)

where D=4A (A−HK).

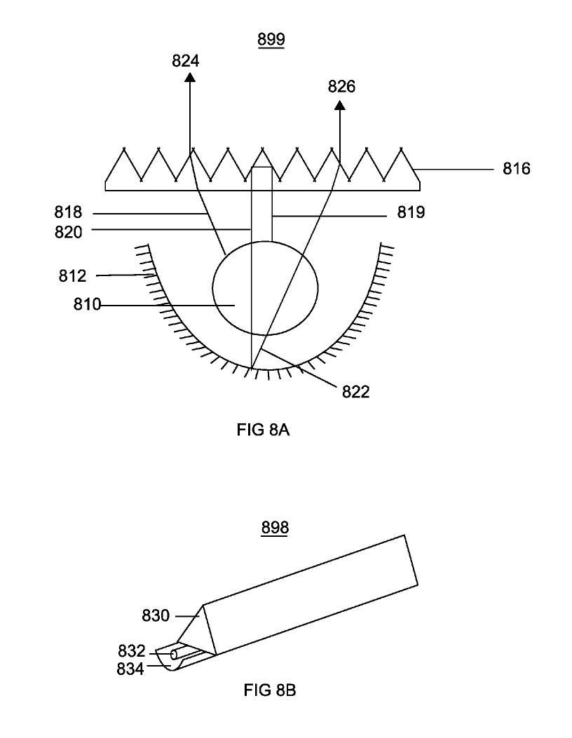

FIG. 8A is a side view of a directional linear light source 899, according to an embodiment. A linear light source 810 is placed in between a reflector 812 and a prism sheet 816. In an embodiment the reflector 812 is parabolic in shape. In an embodiment, the linear light source 810 is placed at the focus of the reflector. In another embodiment, the reflector has an open rectangular cross section, and the linear light source 810 also has a rectangular cross section. The prism sheet 816 restricts the emanating light to a narrow cone of directions. An exemplary light ray 818 is deflected into a direction within a narrow cone of directions as light ray 824. Another exemplary light ray 819 is reflected back by prismatic sheet 816 into light ray 820. In an embodiment the linear light source 810 is primarily transparent, and thus most of the light 820 passes through it and is reflected from the reflector 812 as light 822. This light 822 may pass through the linear light source 810 one or more times, and be reflected by the prism sheet 816 and reflector 812 multiple times, till it impinges upon the prism sheet again (as light 822) and is refracted from the prismatic sheet 816 as light 826, traveling in a direction within a narrow cone of directions. The transparency of the transparent linear light source 810 thus results in increased efficiency of extraction of light.

FIG. 8B illustrates a directional linear light source 898 using a single prism, according to an embodiment. A linear source of light 832 is placed between a reflector 834 and a transparent prism 830. The prism 830 restricts emanating light into a narrow cone of directions.

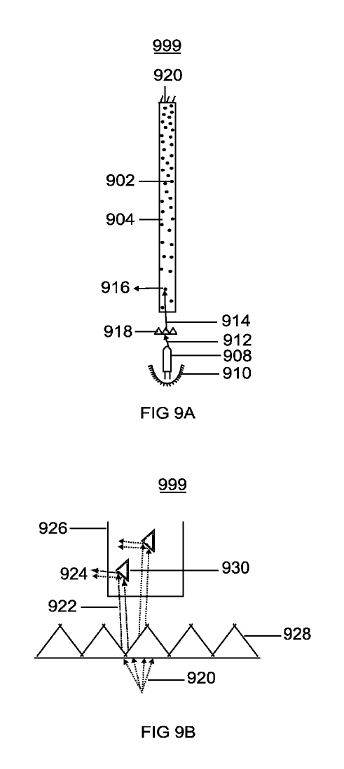

FIG. 9A illustrates a directional linear light source 999 having aspherical particles, according to one embodiment. A linear light guide 904 contains a fine dispersion of light deflecting particles 902, at a very small concentration. The light deflecting particles 902 are aspherical, and oriented according to a suitable orientation distribution profile. An orientation distribution profile is a function that relates a particle's position in the light guide to its orientation. Near one end of the linear light guide 904, a point light source 908 is placed. In an embodiment, a reflector 910 is placed near the point light source 908. The light from the point light source 908 enters light guide 904 and is emitted over the entire surface of the light guide 904 due to the light deflecting particles 902. A prism sheet 918 (or a prism) is placed between the point light source 908 and the linear light guide 904 to restrict light to a narrow range of angles. An exemplary light ray 912 emerging from the point light source 908 is converted into a nearly vertical light ray 914 after passing through the prism sheet 918. The aspherical light deflecting particles 902 deflect light traveling in a narrow cone within the light guide 904 into light in a narrow cone emanating from the light guide 904, such as light 916. In an embodiment, the particles 902 are right angled isosceles triangular prismatic, cuboidal or cubical in shape, and are oriented so that the light reflected from the particles 902 will be primarily in the direction depicted by deflected ray 916. In an embodiment, top edge 920 of the light source column 904 is mirrored, such that it will reflect light back into light guide 904.

The light emanation pattern pertaining to a particle depends on its size, shape and orientation. Aspherical particles of a suitable shape, when collectively oriented in a particular manner, impart a required light emanation pattern to the light guide. To vary the direction of emanation according to position, the aspherical particles 902 are oriented such that particle orientation is a function of its position in the light guide.

The point light source 908 and prism sheet 918 together act as a directional point light source. In an embodiment, other directional point light source, such as a LASER may be used in place of this combination of elements.

FIG. 9B is a detailed partial view of directional linear light source 999 having aspherical particles, according to one embodiment. A linear light source 926 contains a fine dispersion of oriented right angled prismatic particles 930. Light rays 920 emerging from a point light source pass through the prism sheet 928 and are converted into light rays 922 that are nearly vertical. The light rays 922 are incident on the particles 930 in the linear light source, and the light rays 924 emerging from the linear light source are restricted to a narrow cone of directions.

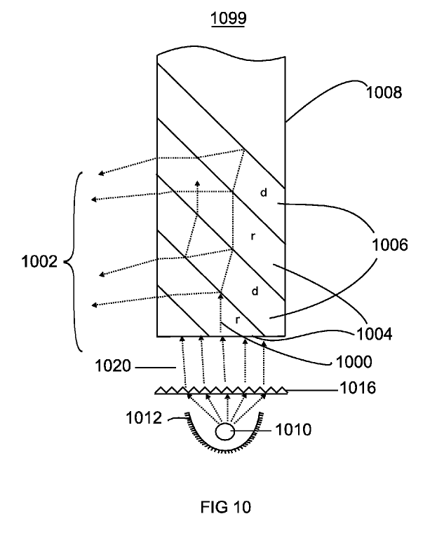

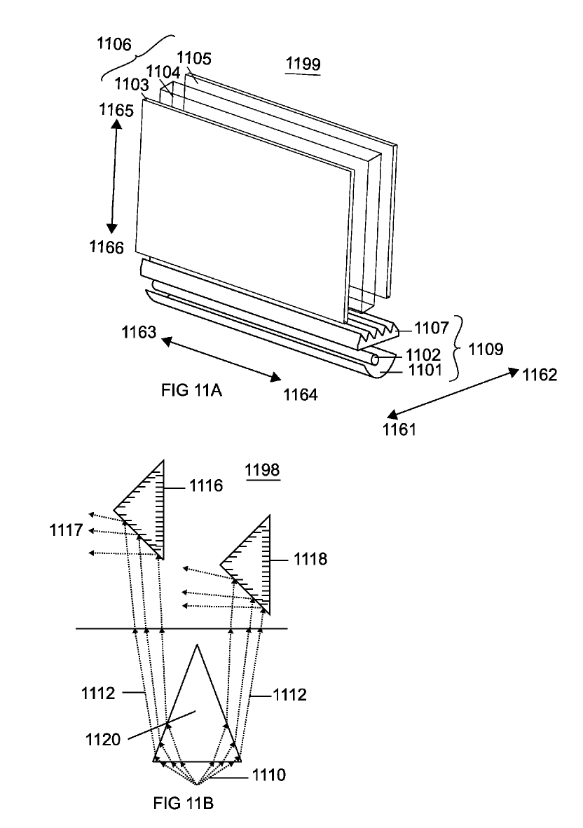

FIG. 10 illustrates a directional linear light source 1099 having slanted sheets, according to one embodiment. A linear light guide 1008 has transparent sheets 1004 and 1006 having different refractive indexes. In an embodiment the transparent sheets 1004 have a lower refractive index than that of transparent sheets 1006. In an embodiment the sheets 1004 are placed alternately with the sheets 1006 and make a particular angle with the side of light guide 1008. A directional point light source emits light into one end of the light guide 1008. In an embodiment, directional point light source comprises a prism sheet 1016, a point light source 1010 and an optional reflector 1012. Light rays 1020 emanating from the directional point light source, are restricted to a narrow cone of directions. An exemplary light ray 1000 traverses the light guide 1008. At each interface between the transparent sheets 1004 and 1006, the light ray 1000 is partially reflected out of the light guide 1008 and is partially refracted into the next sheet. Light rays 1002 emanate out of the light guide 1008 due to partial reflection at the interfaces of the transparent sheets 1004 and 1006. By varying the refractive indexes, slopes and thicknesses of the individual sheets 1004 and 1006, the emanated light rays 1002 form a predetermined light emanation pattern. According to an embodiment, the transparent sheets are placed such that, when vertical light 1020 is incident upon them, it is emanated primarily horizontally.

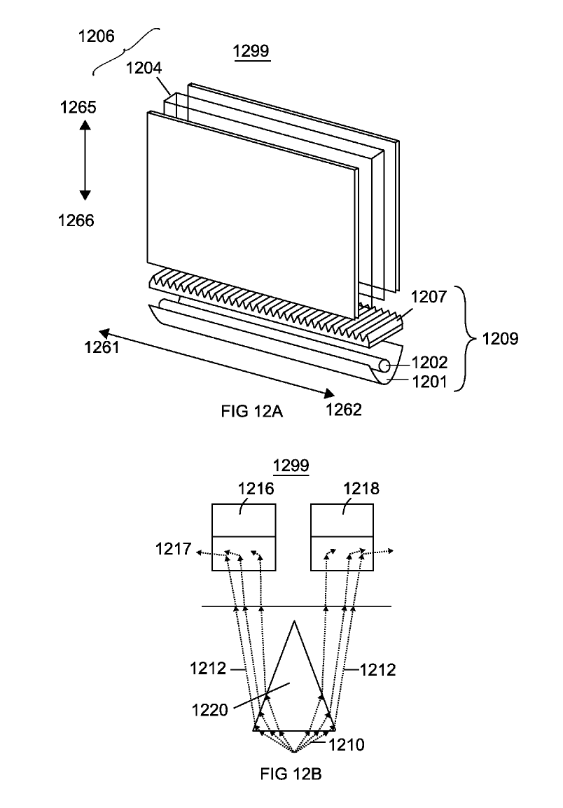

FIG. 11A illustrates a directional surface light source 1199, according to one embodiment. A light guide 1106 is made up out of three sheets joined at their larger faces, each one transparent to light, the core 1104 being of higher refractive index than the cladding sheets 1103 and 1105. The core 1104 preferably has three of its edges made so as to reflect light. The cladding sheets 1103 and 1105 may be a solid, liquid, gas (such as air) or vacuum. Adjacent to one edge of core 1104, a directional linear light source 1109 is situated. The directional linear light source 1109 emits light in a narrow cone of directions, which enters the core 1104, and is guided through it. The core 1104 deflects guided light having a narrow cone of directions, into light emanating from the light guide 1106 in a narrow cone of directions. In an embodiment, light deflecting particles are provided throughout the core 1104. The light deflecting particles may be aspherical (such as right angled isosceles prismatic, or cubical) in shape, and are oriented so that when vertical light is incident upon them, the reflected light is restricted to a narrow range of angles normal to the surface of the backlight.

In an embodiment, directional linear light source 1109 comprises a linear light source 1102, an optional reflector 1101 and a prism sheet 1107. In an embodiment, the prism sheet 1107 is oriented such that the prism rows are parallel to the linear light source 1102. Because of this, the light entering the core 1104 has a narrow spread in the directions denoted by 1161 and 1162. The light emanating from surface light source 1199 will then be narrowly spread in the directions denoted by 1165 and 1166. Thus, the light source 1199 will emanate light generally as if there were a prismatic sheet with prisms oriented parallel to the directions denoted by 1163 and 1164. Yet, no prismatic sheet on the surface of the directional surface light source 1199 is actually used. If a small concentration of light deflecting particles are provided in the core 1104, the core 1104 will be transparent to light entering from outside. The apparatus will then act as a directional surface light source that is transparent to light.

FIG. 11B is a detailed partial side view of a directional surface light source 1199, according to one embodiment. A prism 1120 from the prism sheet restricts outgoing light to a narrow range of angles. Light rays 1110 emerging from the linear light source pass through the prism 1120 and are converted into light rays 1112 that are nearly vertical. The light rays 1112 are incident on the particles 1116 and 1118 in the core, and the light rays 1117 emerging from the backlight are restricted to a narrow range of angles.

FIG. 12A illustrates a directional surface light source 1299, according to one embodiment. A light guide 1206, has a directional linear light source 1209 near one edge. The light guide 1206 has a core 1204 that deflects guided light having a narrow cone of directions into light emanating from the light guide 1206 in a narrow cone of directions. The prisms of the prism sheet 1207 are oriented perpendicular to the linear light source 1202. Because of this, the light entering the core 1204 has a narrow spread in the directions denoted by 1261 and 1262. The light emanating from surface light source 1299 will be narrowly spread in the directions denoted by 1261 and 1262. Thus, the light source 1299 will emanate light generally as if there were a prismatic sheet with prisms oriented parallel to the directions denoted by 1265 and 1266. In an embodiment, the apparatus acts as a directional surface light source that is transparent to light.

In order to restrict the emanation of light in both the direction 1261 and 1262 as well as the direction 1265 and 1266, one can use two prism sheets one on top of the other, with their prisms perpendicular to each other.

FIG. 12B is a detailed partial front view of a directional surface light source 1299, according to an embodiment. A prism 1220 from the prism sheet restricts outgoing light to a narrow range of angles. Light rays 1210 emerging from the linear light source in all directions pass through the prism 1220 and are converted into light rays 1212 that are nearly vertical. The light rays 1212 are incident on the particles 1216 and 1218 in the core, and the light rays 1217 emerging from the backlight are restricted to a narrow range of angles.

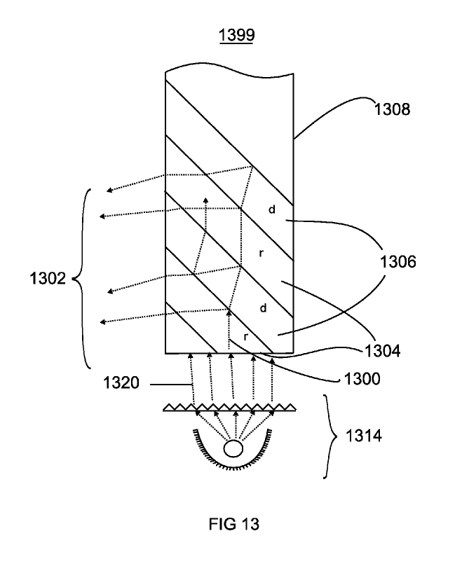

FIG. 13 is a side view of a directional surface light source 1399, according to one embodiment. A sheet light guide 1308 comprises transparent sheets 1304 and 1306 having different refractive indexes. In an embodiment the transparent sheets 1304 have a lower refractive index than that of transparent sheets 1306. In an embodiment the sheets 1304 are placed alternately with the sheets 1306 and make a particular angle with the side of sheet light guide 1308. A directional linear light source 1314 emits light into one edge of the sheet light guide 1308. Light rays 1320 emanating from the directional linear light source 1314, are restricted to a narrow cone of directions. An exemplary light ray 1300 traverses the sheet light guide 1308. At each interface between the transparent sheets 1304 and 1306, the light ray 1300 is partially reflected out of the light guide 1308 and is partially refracted into the next sheet. Light rays 1302 emanate out of light guide 1308 due to partial reflection at the interfaces of the transparent sheets 1304 and 1306. By varying the refractive indexes, slopes and thicknesses of the individual sheets 1304 and 1306, the emanated light rays 1302 form a predetermined light emanation pattern.

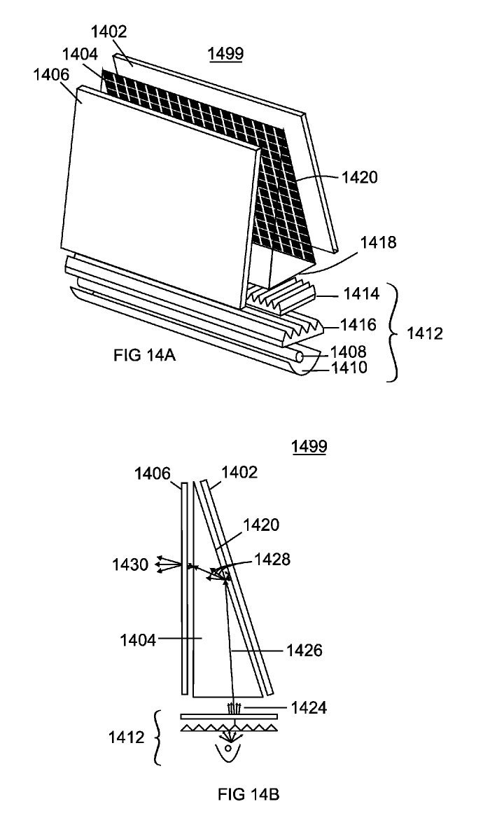

FIG. 14A illustrates a surface light source 1499 having an etched tapering sheet light guide 1404. The sheet light guide 1404 is tapering from one edge 1418 to the opposite edge. The central sheet 1404 has its larger face 1420 etched. In an embodiment, a light diffuser sheet 1406 is provided. In an embodiment, a reflector 1402 directs all light towards one exit surface. Adjacent to the edge 1418, a directional linear light source 1412 is placed. In an embodiment, the directional linear light source 1412 comprises a linear light source 1408, an optional reflector 1410, and two prism sheets 1414 and 1416, arranged with their prisms perpendicular to each other.

FIG. 14B is the side view of a surface light source 1499, having an etched tapering sheet light guide. Exemplary light rays 1424 are emitted by the directional linear light source 1412, restricted to a narrow range of angles about the vertical direction. An exemplary light ray 1426 meets the etched surface 1420. Because of the etching on the surface 1420, this light is transmitted and reflected in multiple directions. The light 1428 dispersed from the surface 1420 emanates out of the light diffuser 1406 as light 1430. The light that is transmitted through the etched surface 1420 is reflected by the reflector 1402 to emanate out of the opposite face.

In an embodiment, since directional light 1424 enters the sheet light guide 1404, the etching at all locations on the triangular light guide can be uniform at all locations. Complex etching patterns are not necessary.

An apparatus and method for providing a linear light source emitting light in a narrow cone of directions is disclosed. It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. An apparatus comprising:
a linear light source and
a first prism sheet.

2. The apparatus of claim 1, wherein the first prism sheet is oriented in such a way that the prism rows are parallel to the linear light source.

3. The apparatus of claim 1, wherein the first prism sheet is oriented in such a way that the prism rows are perpendicular to the linear light source.

4. The apparatus of claim 1, further comprising a reflector.

5. The apparatus of claim 1, further comprising a second prism sheet oriented in such a way that the prism rows of the second prism sheet are perpendicular to the prism rows of the first prism sheet.

6. The apparatus of claim 1, wherein the linear light source is transparent.

7. The apparatus of claim 1, wherein the linear light source allows light reflected from the first prism sheet to pass through it.

8. The apparatus of claim 1, wherein the first prism sheet comprises a single prism.

9. An apparatus comprising
a directional light source and
a light guide wherein the light guide deflects light conducted in a narrow cone of directions into light in a narrow cone of directions that emanates out of the light guide.

10. The apparatus of claim 9, wherein the light guide comprises light deflecting particles.

11. The apparatus of claim 10, wherein the light deflecting particles are aspherical in shape.

12. The apparatus of claim 10, wherein the light deflecting particles are oriented according to an orientation distribution profile.

13. The apparatus of claim 10, wherein the light deflecting particles are right angled isosceles triangular in shape.

14. The apparatus of claim 10, wherein the light deflecting particles are cuboidal in shape.

15. The apparatus of claim 9, wherein the light guide comprises transparent sheets with different refractive indexes.

16. The apparatus of claim 9, wherein the directional light source is a point light source and the light guide is a linear light guide.

17. The apparatus of claim 9, wherein the directional light source is a linear light source and the light guide is a sheet light guide.

18. An apparatus comprising:
a directional linear light source and
an etched tapering sheet light guide.
